(19) United States
(12) Patent Application Publication
(10) Pub. No.: US 2026/0261556 A1
(43) Pub. Date: Sep. 3, 2026

(54) SERVICE PROVIDING METHODS AND APPARATUSES FOR THIRD-PARTY MINI-PROGRAMS

(71) Applicant: Alipay (Hangzhou) Information Technology Co., Ltd., Hangzhou (CN)

(72) Inventors: Wanqiao ZHANG, Hangzhou (CN); Lin HUANG, Hangzhou (CN); Shangcheng SHI, Hangzhou (CN); Wenjie LI, Hangzhou (CN)

(21) Appl. No.: 19/165,107

(22) PCT Filed: Apr. 22, 2024
(86) PCT No.: PCT/CN2024/089076

§ 371 Date: Sep. 13, 2025

(30) Foreign Application Priority Data
May 18, 2023 (CN) 202310571249.7

(51) Int. Cl. H04L 9/40; H04L 9/08

(52) U.S. Cl. CPC H04L 63/10; H04L 9/0819; H04L 9/0838; H04L 9/0861

(57) ABSTRACT

Embodiments of this specification provide service providing methods and apparatuses for third-party mini-programs. In the method, a second-party server generates and stores an application key (AppKey); delivers the AppKey to a first-party client; obtains an open authentication system identifier (OpenID), and generates a session identifier (SessionID); establishes a correspondence between the AppKey, the OpenID, and the SessionID; receives a service data request sent by the first-party client; determines whether a SessionID and an AppKey that are carried in the service data request conform to the established correspondence; and if yes, sends, to a third-party server, a service resource request that carries a service parameter and an OpenID corresponding to the SessionID carried in the service data request; and sends response data to the first-party client.

### TECHNICAL FIELD

One or more embodiments of this specification relate to network communication technologies, and in particular, to service providing methods and apparatuses for third-party mini-programs.

### BACKGROUND

With the continuous development of software development technologies, mini-programs gradually enter the public view due to their convenience and lightweight features. A mini-program is an application that can be used without downloading and installing. As third-party software, the mini-program needs to run on a host program. The host program provides, for a third-party mini-program, a service interface that can implement various service functions. For example, an Alipay mini-program, a 360 mini-program, and a Toutiao mini-program currently appear.

When a service is provided for the third-party mini-program, the following network nodes are generally involved: a third-party client (that is, an application for loading the third-party mini-program on a terminal device), a third-party server (that is, a server that provides a service for the third-party mini-program), a second-party server, a first-party client (that is, an application for loading the host program on the terminal device), and a first-party server (that is, a server that provides a service for the host program). The first-party server stores an original user ID of a user. To alleviate privacy leakage of the original user ID, the second-party server stores an OpenID mapped from the original user ID. When a service is provided for the third-party mini-program, the OpenID instead of the original user ID is used as an identifier of the user, and a service is provided for the third-party mini-program through processing by the second-party server.

However, in a related technology, a service resource allocated to the third-party mini-program is often embezzled. This greatly reduces security.

### SUMMARY

One or more embodiments of this specification describe service providing methods and apparatuses for third-party mini-programs, to improve service security of the third-party mini-program.

According to a first aspect, a service providing method for a third-party mini-program is provided, where the method includes: generating and storing an application key AppKey; delivering the AppKey to a first-party client, so the first-party client delivers the AppKey to a third-party client; obtaining an open authentication system identifier OpenID, and generating a session identifier SessionID; establishing a correspondence between the AppKey, the OpenID, and the SessionID; receiving a service data request sent by the first-party client, where the service data request carries the SessionID, an AppKey, and a service parameter; determining whether the SessionID and the AppKey that are carried in the service data request conform to the established correspondence; if yes, sending a service resource request to a third-party server, where the service resource request carries the service parameter and an OpenID corresponding to the SessionID carried in the service data request; and sending, to the first-party client, response data returned by the third-party server, so the first-party client sends the response data to the third-party client.

According to a second aspect, a service providing method for a third-party mini-program is provided, where the method includes: receiving an AppKey sent by a first-party client; sending a third-party login request to the first-party client; after a login success response sent by the first-party client is received, sending a service data request to the first-party client, where the service data request carries the AppKey and a service parameter; and receiving response data sent by the first-party client.

According to a third aspect, a service providing method for a third-party mini-program is provided, where the method includes: receiving an AppKey sent by a second-party server; sending the AppKey to a third-party client; sending, to the second-party server, a third-party login request sent by the third-party client; receiving a session identifier SessionID sent by the second-party server, and sending a login success response to the third-party client; receiving a service data request sent by the third-party client, where the service data request carries an AppKey and a service parameter; sending, to the second-party server, the service data request that carries the SessionID, the AppKey, and the service parameter; and receiving response data sent by the second-party server, and sending the response data to the third-party client.

According to a fourth aspect, a service providing apparatus for a third-party mini-program is provided, where the apparatus includes: an application key processing module, configured to: generate and store an application key AppKey, and send the AppKey to a first-party client; an identifier acquisition module, configured to: obtain an open authentication system identifier OpenID, and generate a session identifier SessionID; a correspondence establishment module, configured to establish a correspondence between the AppKey, the OpenID, and the SessionID; a service processing module, configured to: receive a service data request sent by the first-party client, where the service data request carries the SessionID, an AppKey, and a service parameter, and determine whether the SessionID and the AppKey that are carried in the service data request conform to the established correspondence; a resource acquisition module, configured to: after the service processing module determines that the SessionID and the AppKey conform to the correspondence, send a service resource request to a third-party server, where the service resource request carries the service parameter and an OpenID corresponding to the SessionID carried in the service data request; and a response data processing module, configured to send, to the first-party client, response data returned by the third-party server, so the first-party client sends the response data to the third-party client.

According to a fifth aspect, a service providing apparatus for a third-party mini-program is provided, where the apparatus includes: an application key acquisition module, configured to receive an AppKey sent by a first-party client; a login request module, configured to send a third-party login request to the first-party client; a resource request module, configured to: after a login success response sent by the first-party client is received, send a service data request to the first-party client, where the service data request carries the AppKey and a service parameter; and a resource data receiving module, configured to receive response data sent by the first-party client.

According to a sixth aspect, a service providing apparatus for a third-party mini-program is provided, where the apparatus includes: an AppKey forwarding module, configured to: receive an AppKey sent by a second-party server, and send the AppKey to a third-party client; a login processing module, configured to: send, to the second-party server, a third-party login request sent by the third-party client, receive a session identifier SessionID sent by the second-party server, and send a login success response to the third-party client; a service data request forwarding module, configured to: receive a service data request sent by the third-party client, where the service data request carries an AppKey and a service parameter, and send, to the second-party server, the service data request that carries the SessionID, the AppKey, and the service parameter; and a response data forwarding module, configured to: receive response data sent by the second-party server, and send the response data to the third-party client.

According to a seventh aspect, a computing device is provided, including a memory and a processor, where the memory stores executable code, and the processor executes the executable code to implement the method according to any embodiment of this specification.

To alleviate a case in which a service resource allocated to a third-party mini-program is embezzled, it needs to be ensured that a third-party client that initiates a login connection in an initial phase and a third-party client that subsequently requests a resource are the same client. Therefore, in the service providing method and apparatus for a third-party mini-program provided in the embodiments of this specification, in a first phase, that is, in a phase in which the third-party client initiates login, the second-party server sends the AppKey to the third-party client by using the first-party client, so the third-party client that initiates login obtains information about the AppKey. Subsequently, in a second phase, that is, when the third-party client requests resource data, the second-party server obtains, from the service data request, the AppKey from the current third-party client. If the AppKey obtained by the second-party server in the second phase is the same as the AppKey delivered by the second-party server in the first phase, it indicates that the third-party client that initiates login in the first phase and the third-party client that obtains the resource data in the second phase are the same client, so the resource data is not leaked. Therefore, the response data is sent, by using the first-party client, to the third-party client that requests the resource data. If the AppKey obtained by the second-party server in the second phase is different from the AppKey delivered by the second-party server in the first phase, it indicates that the third-party client that initiates login in the first phase and the third-party client that obtains the resource data in the second phase are not the same client. If the response data is provided, the resource data is leaked. Therefore, the response data is not sent, by using the first-party client, to the third-party client that requests the resource data. It can be understood that, in the method in the embodiments of this specification, a more complete verification procedure is completed for an identity of the third-party client. This greatly improves security of a service providing process of the third-party mini-program.

### BRIEF DESCRIPTION OF DRAWINGS

To describe the technical solutions in some embodiments of this specification or in a related technology more clearly, the following briefly describes the accompanying drawings needed for describing some embodiments or the related technology. Clearly, the accompanying drawings in the following descriptions show some embodiments of this specification, and a person of ordinary skill in the art can still derive other drawings from these accompanying drawings without creative efforts.

FIG. 1 is a schematic diagram illustrating a system architecture to which an embodiment of this specification is applied;

FIG. 2 is a flowchart illustrating a service providing method for a third-party mini-program performed in a second-party server, according to an embodiment of this specification;

FIG. 3 is a flowchart illustrating a service providing method for a third-party mini-program performed in a third-party client, according to an embodiment of this specification;

FIG. 4 is a flowchart illustrating a service providing method for a third-party mini-program performed in a first-party client, according to an embodiment of this specification;

FIG. 5 is a flowchart illustrating a service providing method for a third-party mini-program performed by all parties through cooperation, according to an embodiment of this specification;

FIG. 6 is a schematic structural diagram illustrating a service providing apparatus for a third-party mini-program disposed in a second-party server, according to an embodiment of this specification;

FIG. 7 is a schematic structural diagram illustrating a service providing apparatus for a third-party mini-program disposed in a third-party client, according to an embodiment of this specification; and

FIG. 8 is a schematic structural diagram illustrating a service providing apparatus for a third-party mini-program disposed in a first-party client, according to an embodiment of this specification.

### DESCRIPTION OF EMBODIMENTS

The solutions provided in this specification are described below with reference to the accompanying drawings.

First, it is worthwhile to note that the terms used in the embodiments of this specification are merely for describing specific embodiments, and are not intended to limit this specification. The terms “a”, “said”, and “the” of singular forms used in the embodiments of this specification and the appended claims are also intended to include plural forms, unless otherwise specified in the context clearly.

It should be understood that the term “and/or” used in this specification merely describes an association relationship between associated objects, and indicates that three relationships can exist. For example, “A and/or B” can indicate the following three cases: Only A exists, both A and B exist, and only B exists. In addition, the character “/” usually indicates an “or” relationship between associated objects.

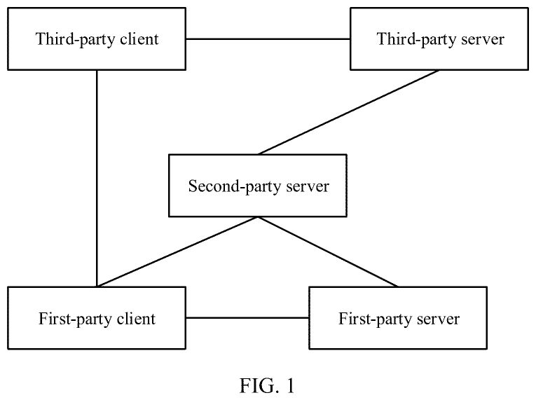

To facilitate understanding of the methods provided in this specification, a system architecture used in and applicable to this specification is first described. As shown in FIG. 1, the system architecture mainly includes five types of network nodes: a third-party client (that is, an application side for loading a third-party mini-program on a terminal device), a third-party server (that is, a server that provides a service resource for the third-party mini-program), a second-party server (configured to isolate a first-party server from the third-party server for security), a first-party client (that is, an application side for loading a host program on the terminal device), and the first-party server (that is, a server that provides a service for the host program).

Both the third-party client and the first-party client are installed and run on the terminal device. The terminal device can include but is not limited to a smart mobile terminal, a smart home device, a network device, a wearable device, a smart medical device, and a PC (personal computer). The smart mobile device can include a mobile phone, a tablet computer, a notebook computer, a PDA (personal digital assistant), and an Internet vehicle. The smart home device can include a smart home appliance such as a smart TV, a smart air conditioner, a smart water heater, a smart refrigerator, and a smart air purifier. The smart home device can further include a smart door lock, a smart socket, a smart light, and a smart camera. The network device can include a switch, a wireless AP, a server, etc. The wearable device can include a smart watch, smart glasses, a smart band, a virtual reality device, an augmented reality device, a mixed reality device (that is, a device that can support virtual reality and augmented reality), etc. The smart medical device can include a smart thermometer, a smart blood pressure monitor, and a smart glucose meter.

It should be understood that a quantity of various network nodes in FIG. 1 is merely an example. Any quantity can be selected and arranged based on an actual implementation requirement.

The method in the embodiments of this specification mainly relates to processing by the second-party server, processing by the third-party client, and processing by the first-party client. The following separately describes the above-mentioned processing by using different embodiments.

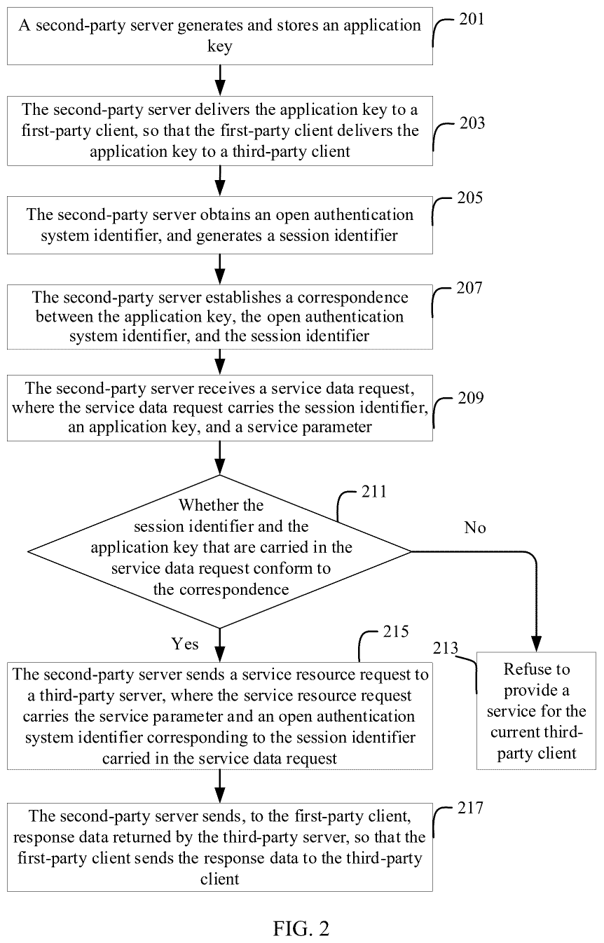

Processing in the second-party server is first described. FIG. 2 is a flowchart illustrating a service providing method for a third-party mini-program performed in a second-party server, according to an embodiment of this specification. The method is performed by a service providing apparatus for a third-party mini-program. The apparatus can be located in the second-party server. It can be understood that the method can alternatively be performed by any apparatus, device, platform, or device cluster having computing and processing capabilities. As shown in FIG. 2, the method includes step 201 to step 217.

Step 201: The second-party server generates and stores an application key (AppKey). Step 203: The second-party server delivers the AppKey to a first-party client, so the first-party client delivers the AppKey to a third-party client. Step 205: The second-party server obtains an open authentication system identifier (OpenID), and generates a session identifier (SessionID). Step 207: The second-party server establishes a correspondence between the AppKey, the OpenID, and the SessionID. Step 209: The second-party server receives a service data request sent by the first-party client, where the service data request carries the SessionID, an AppKey, and a service parameter. Step 211: The second-party server determines whether the SessionID and the AppKey that are carried in the service data request conform to the established correspondence; and if yes, performs step 215; otherwise, performs step 213.

Step 213: Refuse to provide a service for the current third-party client, and end the current procedure.

Step 215: The second-party server sends a service resource request to a third-party server, where the service resource request carries the service parameter and an OpenID corresponding to the SessionID carried in the service data request. Step 217: The second-party server sends, to the first-party client, response data returned by the third-party server, so the first-party client sends the response data to the third-party client.

The above-mentioned procedure shown in FIG. 2 describes processing in the second-party server. Corresponding to the processing in the second-party server shown in FIG. 2, the third-party client and the first-party client also need to cooperate to complete corresponding processing.

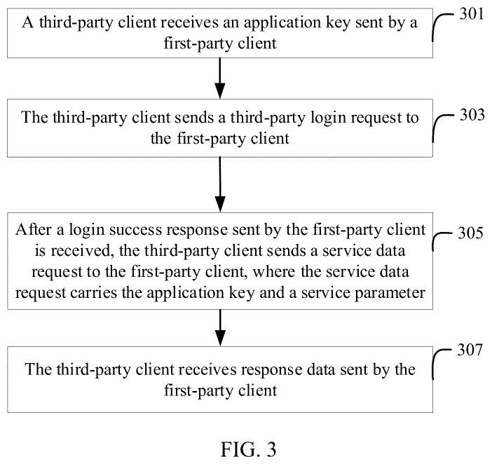

The following describes corresponding processing that is performed in the third-party client and that corresponds to the processing in the second-party server shown in FIG. 2. FIG. 3 is a flowchart illustrating a service providing method for a third-party mini-program performed in a third-party client, according to an embodiment of this specification. The method is performed by a service providing apparatus for a third-party mini-program. The apparatus can be located in the third-party client. It can be understood that the method can alternatively be performed by any apparatus, device, platform, or device cluster having computing and processing capabilities. Referring to FIG. 3, the method includes the following steps: Step 301: The third-party client receives an AppKey sent by a first-party client. Step 303: The third-party client sends a third-party login request to the first-party client. Step 305: After a login success response sent by the first-party client is received, the third-party client sends a service data request to the first-party client, where the service data request carries the AppKey and a service parameter. Step 307: The third-party client receives response data sent by the first-party client.

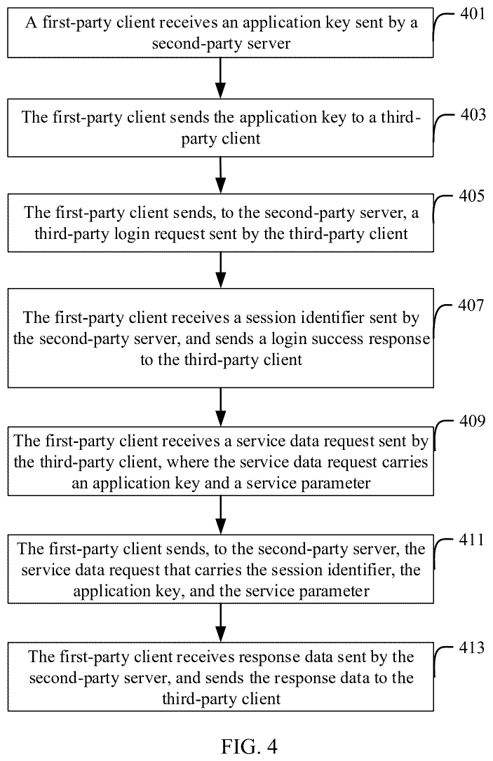

The following describes corresponding processing that is performed in the first-party client and that corresponds to the processing in the second-party server shown in FIG. 2. FIG. 4 is a flowchart illustrating a service providing method for a third-party mini-program performed in a first-party client, according to an embodiment of this specification. The method is performed by a service providing apparatus for a third-party mini-program. The apparatus can be located in the first-party client. It can be understood that the method can alternatively be performed by any apparatus, device, platform, or device cluster having computing and processing capabilities. Referring to FIG. 4, the method includes the following steps: Step 401: The first-party client receives an AppKey sent by a second-party server. Step 403: The first-party client sends the AppKey to a third-party client. Step 405: The first-party client sends, to the second-party server, a third-party login request sent by the third-party client. Step 407: The first-party client receives a session identifier SessionID sent by the second-party server, and sends a login success response to the third-party client. Step 409: The first-party client receives a service data request sent by the third-party client, where the service data request carries an AppKey and a service parameter. Step 411: The first-party client sends, to the second-party server, the service data request that carries the SessionID, the AppKey, and the service parameter. Step 413: The first-party client receives response data sent by the second-party server, and sends the response data to the third-party client.

As described above, in a related technology, a service resource allocated to the third-party mini-program is often embezzled. This greatly reduces security. For example, on a platform of a host program, there are a plurality of third-party mini-programs (that is, a plurality of third-party clients). Clients of the plurality of third-party mini-programs obtain, by using the same host program (that is, the same first-party client), service resources needed by the clients. As a result, it is likely that a third-party client A obtains a SessionID of a session originally belonging to a third-party client B, and consequently the third-party client A obtains a service resource that should have been provided for the third-party client B. For another example, by initiating an attack, an attacker can also obtain a service resource that should have been provided for the third-party client B. Therefore, security in the related technology needs to be improved.

In the embodiments of this specification, to alleviate a case in which a service resource allocated to a third-party mini-program is embezzled, it needs to be ensured that a third-party client that initiates a login connection in an initial phase and a third-party client that subsequently requests a resource are the same client. Therefore, with reference to the above-mentioned procedures shown in FIG. 2, FIG. 3, and FIG. 4, in the service providing method for a third-party mini-program provided in the embodiments of this specification, in a first phase, that is, in a phase in which the third-party client initiates login, the second-party server sends the AppKey to the third-party client by using the first-party client, so the third-party client that initiates login obtains information about the AppKey. Subsequently, in a second phase, that is, when the third-party client requests resource data, the second-party server obtains, from the service data request, the AppKey from the current third-party client. If the AppKey obtained by the second-party server in the second phase is the same as the AppKey delivered by the second-party server in the first phase, it indicates that the third-party client that initiates login in the first phase and the third-party client that obtains the resource data in the second phase are the same client, so the resource data is not leaked. Therefore, the response data is sent, by using the first-party client, to the third-party client that requests the resource data. If the AppKey obtained by the second-party server in the second phase is different from the AppKey delivered by the second-party server in the first phase, it indicates that the third-party client that initiates login in the first phase and the third-party client that obtains the resource data in the second phase are not the same client. If the response data is provided, the resource data is leaked. Therefore, the response data is not sent, by using the first-party client, to the third-party client that requests the resource data. It can be understood that, in the method in the embodiments of this specification, a more complete verification procedure is completed for an identity of the third-party client. This greatly improves security of a service providing process of the third-party mini-program.

In the above-mentioned processes shown in FIG. 2, FIG. 3, and FIG. 4, in the above-mentioned first phase, the third-party client obtains the AppKey delivered by the second-party server. Specifically, in the third-party client, before the above-mentioned step 301, the method includes: In the first phase in which the third-party client requests login, the third-party client sends, to the first-party client, an initialization key pre-agreed upon with a second-party server. Correspondingly, in the first-party client, before the above-mentioned step 401, the method further includes: The first-party client sends, to the second-party server, an initialization key sent by the third-party client. Correspondingly, in the second-party server, before the above-mentioned step 201, the method further includes: The second-party server receives an initialization key that is pre-agreed upon with the third-party client and that is forwarded by the first-party client, verifies the initialization key, and if the verification succeeds, performs step 201 of generating and storing an AppKey.

In the above-mentioned processes shown in FIG. 2, FIG. 3, and FIG. 4, the SessionID can be further encrypted, so an encrypted SessionID is transmitted among all the parties, to further alleviate the following case: Another party embezzles the SessionID of the third-party client participating in a session, and consequently embezzles a service resource of the third-party client participating in a session. Specifically, in the second-party server, after step 205 of generating a SessionID and before step 209 of receiving a service data request sent by the first-party client, the method further includes: The second-party server encrypts the SessionID by using the AppKey, and sends an encrypted SessionID to the first-party client. Correspondingly, the first-party client sends the encrypted SessionID to the third-party client. Correspondingly, the third-party client decrypts the SessionID by using the AppKey, sends the SessionID to the first-party client, so the first-party client caches the SessionID.

In the embodiments of this specification, encrypted transmission of the service parameter can be further implemented, to further improve security. A specific implementation includes: In the second-party server, after step 205 of generating a SessionID and before step 209 of receiving a service data request sent by the first-party client, the method further includes: generating a session key, where the session key has a same lifecycle as the SessionID, and sending the session key and the SessionID to the first-party client.

Then, in the first-party client, the first-party client receives a session key sent by the second-party server, and stores the session key. Before step 411 of sending the service data request to the second-party server, the method further includes: The first-party client encrypts, by using the stored session key, the service parameter in the service data request sent to the second-party server. That is, the service data request sent by the first-party client to the second-party server carries a service parameter encrypted by using the session key. Then, in the second-party server, after it is determined in step 211 that the SessionID and the AppKey that are carried in the service data request conform to the established correspondence and before the second-party server sends the service resource request to the third-party server, the second-party server decrypts an encrypted service parameter in the service data request by using the session key, to obtain the service parameter, so the service parameter can be carried in the service resource request in step 215.

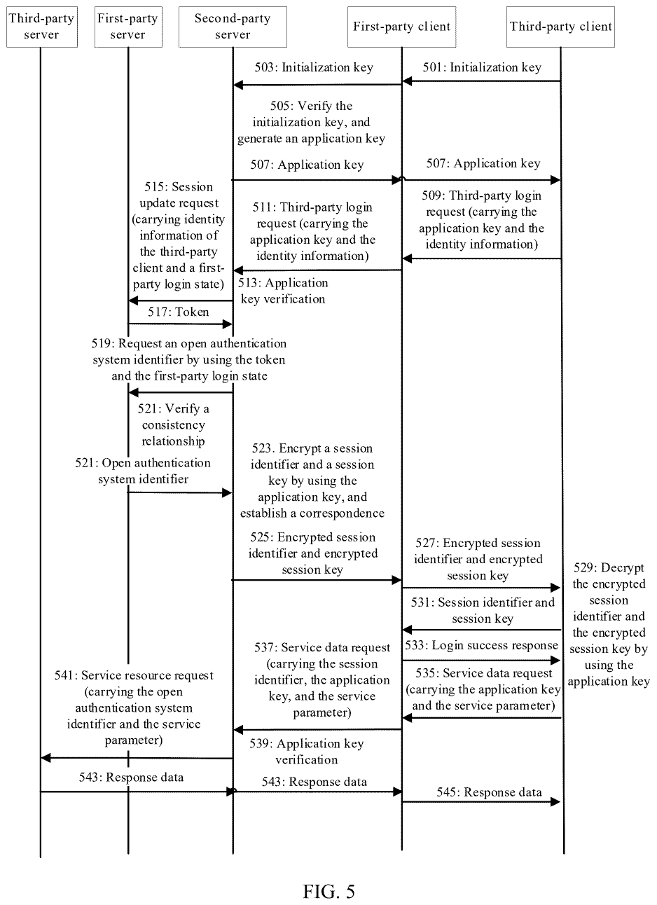

The following describes a flowchart illustrating a service providing method for a third-party mini-program in the embodiments of this specification through cooperation among all the parties in the system shown in FIG. 1. As shown in FIG. 5, the method includes step 501 to step 545.

Step 501: When a service of a corresponding a third-party client is required, the third-party client sends, to the first-party client, an initialization key pre-agreed upon with the second-party server.

Step 503: The first-party client sends the initialization key to the second-party server.

Step 505: The second-party server verifies the received initialization key, and generates an AppKey after the verification succeeds.

Step 507: The second-party server sends the AppKey to the first-party client, so the first-party client sends the AppKey to the third-party client.

Step 509: The third-party client sends a third-party login request to the first-party client, where the third-party login request is used to request to establish a session connection for the third-party client, and the third-party login request carries an AppKey and identity information of the third-party client.

For example, the third-party client corresponds to a third-party mini-program that processes user electricity bills on an Alipay platform. The first-party client corresponds to a host program of the Alipay platform. When a user needs to check the balance of the electricity bills, the user can click the third-party mini-program, so the third-party login request is sent to the first-party client by using a corresponding third-party client.

Step 511: The first-party client sends the received third-party login request to the second-party server.

Step 513: The second-party server obtains the AppKey from the third-party login request, and performs AppKey verification, that is, determines whether the AppKey carried in the third-party login request is the same as the previously generated AppKey; and performs step 515 if the AppKey carried in the third-party login request is the same as the previously generated AppKey; otherwise, refuses to provide a service for the current third-party client, and ends the current procedure.

Step 515: The second-party server sends, to the first-party server, a session update request that carries the identity information of the third-party client and a first-party login state.

Step 517: The first-party server returns a token corresponding to the current session to the second-party server, and stores a consistency relationship between the token and the received first-party login state.

Step 519: The second-party server requests an OpenID from the first-party server by using the token and the first-party login state.

Step 521: The first-party server verifies whether the token and the first-party login state that are used when the OpenID is requested have the above-mentioned consistency relationship; and if yes, returns an OpenID corresponding to the current session to the second-party server.

Step 523: The second-party server generates a SessionID and a session key based on the received OpenID, encrypts the SessionID and the session key by using the AppKey, and establishes a correspondence between the obtained AppKey, the OpenID, and the SessionID.

Step 525: The second-party server sends an encrypted SessionID and an encrypted session key to the first-party client.

Step 527: The first-party client sends the encrypted SessionID and the encrypted session key to the third-party client.

Step 529: The third-party client decrypts the encrypted SessionID and the encrypted session key by using the AppKey, to obtain the SessionID and the session key.

Step 531: The third-party client sends a decrypted SessionID and a decrypted session key to the first-party client.

Step 533: The first-party client stores the SessionID and the session key, and sends a login success response to the third-party client.

Step 535: After receiving the login success response sent by the first-party client, the third-party client sends a service data request to the first-party client, where the service data request carries the AppKey and a service parameter.

Step 537: The first-party client encrypts the service parameter by using the session key, and sends, to the second-party server, the service data request that carries the SessionID, the AppKey, and an encrypted service parameter.

Step 539: The second-party server performs AppKey verification, that is, determines whether the SessionID and the AppKey that are carried in the service data request conform to the established correspondence; and if yes, performs step 541; otherwise, refuses to provide a service for the current third-party client.

Step 541: The second-party server decrypts the encrypted service parameter by using the session key, and then sends a service resource request to the third-party server, where the service resource request carries the service parameter and an OpenID corresponding to the SessionID in the service data request.

Step 543: The second-party server sends, to the first-party client, response data returned by the third-party server.

Step 545: The first-party client sends the response data to the third-party client.

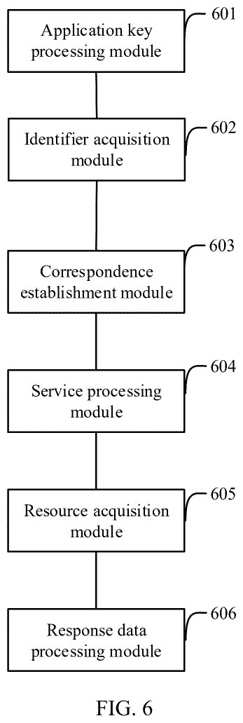

In an embodiment of this specification, a service providing apparatus for a third-party mini-program is provided, and the apparatus is disposed in a second-party server. Referring to FIG. 6, the apparatus includes: an application key processing module 601, configured to: generate and store an application key AppKey, and send the AppKey to a first-party client; an identifier acquisition module 602, configured to: obtain an open authentication system identifier OpenID, and generate a session identifier SessionID; a correspondence establishment module 603, configured to establish a correspondence between the AppKey, the OpenID, and the SessionID; a service processing module 604, configured to: receive a service data request sent by the first-party client, where the service data request carries the SessionID, an AppKey, and a service parameter, and determine whether the SessionID and the AppKey that are carried in the service data request conform to the established correspondence; a resource acquisition module 605, configured to: after the service processing module determines that the SessionID and the AppKey conform to the correspondence, send a service resource request to a third-party server, where the service resource request carries the service parameter and an OpenID corresponding to the SessionID carried in the service data request; and a response data processing module 606, configured to send, to the first-party client, response data returned by the third-party server, so the first-party client sends the response data to the third-party client.

In an embodiment of the apparatus in this specification shown in FIG. 6, the application key processing module 601 is further configured to: before the application key AppKey is generated and stored, receive an initialization key that is pre-agreed upon with the third-party client and that is forwarded by the first-party client, verify the initialization key, and if the verification succeeds, perform the step of generating and storing an AppKey.

In an embodiment of the apparatus in this specification shown in FIG. 6, the service processing module 604 is further configured to: after the SessionID is generated and before the service data request sent by the first-party client is received, encrypt the SessionID by using the AppKey, and send an encrypted SessionID to the first-party client, so the first-party client interacts with the third-party client to enable the first-party client to obtain a decrypted SessionID.

In an embodiment of the apparatus in this specification shown in FIG. 6, the service processing module 604 is further configured to: after the SessionID is generated, and before the service data request sent by the first-party client is received, further generate a session key, where the session key has a same lifecycle as the SessionID, and send the session key and the SessionID to the first-party client. The service parameter in the service data request sent by the first-party client is encrypted by the first-party client by using the session key. After it is determined that the SessionID and the AppKey that are carried in the service data request conform to the established correspondence and before the service resource request is sent to the third-party server, an encrypted service parameter in the service data request is further decrypted by using the session key, to obtain the service parameter.

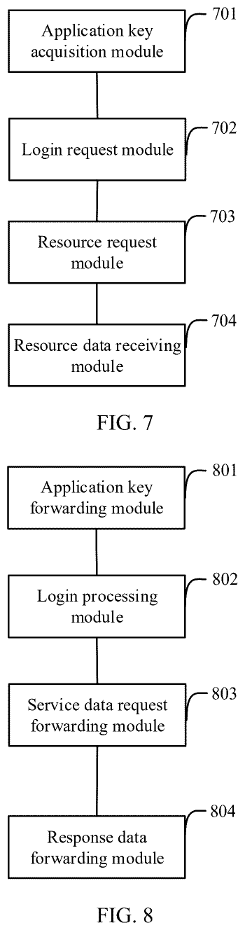

In an embodiment of this specification, a service providing apparatus for a third-party mini-program is provided, and the apparatus is disposed in a third-party client. Referring to FIG. 7, the apparatus includes: an application key acquisition module 701, configured to receive an AppKey sent by a first-party client; a login request module 702, configured to send a third-party login request to the first-party client; a resource request module 703, configured to: after a login success response sent by the first-party client is received, send a service data request to the first-party client, where the service data request carries the AppKey and a service parameter; and a resource data receiving module 704, configured to receive response data sent by the first-party client.

In an embodiment of the apparatus in this specification shown in FIG. 7, the application key acquisition module 701 is further configured to: before the AppKey sent by the first-party client is received, send, to the first-party client, an initialization key pre-agreed upon with a second-party server.

In an embodiment of the apparatus in this specification shown in FIG. 7, the login request module 702 is further configured to: receive an encrypted SessionID and an encrypted session key that are sent by the first-party client, decrypt the encrypted SessionID and the encrypted session key by using the AppKey, to obtain a SessionID and a session key, and send a decrypted SessionID and a decrypted session key to the first-party client.

In an embodiment of this specification, a service providing apparatus for a third-party mini-program is provided, and the apparatus is disposed in a first-party client. Referring to FIG. 8, the apparatus includes: an AppKey forwarding module 801, configured to: receive an AppKey sent by a second-party server, and send the AppKey to a third-party client; a login processing module 802, configured to: send, to the second-party server, a third-party login request sent by the third-party client, receive a session identifier SessionID sent by the second-party server, and send a login success response to the third-party client; a service data request forwarding module 803, configured to: receive a service data request sent by the third-party client, where the service data request carries an AppKey and a service parameter, and send, to the second-party server, the service data request that carries the SessionID, the AppKey, and the service parameter; and a response data forwarding module 804, configured to: receive response data sent by the second-party server, and send the response data to the third-party client.

In an embodiment of the apparatus in this specification shown in FIG. 8, the AppKey forwarding module 801 is further configured to: before the AppKey sent by the second-party server is received, send, to the second-party server, an initialization key sent by the third-party client.

In an embodiment of the apparatus in this specification shown in FIG. 8, if the SessionID that is received by the login processing module 802 and that is sent by the second-party server is an encrypted SessionID, the encrypted SessionID is further sent to the third-party client, and a decrypted SessionID sent by the third-party client is received.

In an embodiment of the apparatus in this specification shown in FIG. 8, the login processing module 802 receives an encrypted SessionID and an encrypted session key that are sent by the second-party server, and sends the encrypted SessionID and the encrypted session key to the third-party client. A decrypted SessionID and a decrypted session key that are sent by the third-party client are received. The service data request sent by the service data request forwarding module 803 to the second-party server carries a service parameter encrypted by using the session key.

Some embodiments of this specification provide a computer-readable storage medium, where the computer-readable storage medium stores a computer program, and when the computer program is executed on a computer, the computer is enabled to perform the method according to any embodiment of this specification.

An embodiment of this specification provides a computing device, including a memory and a processor. The memory stores executable code, and when the processor executes the executable code, the method in any embodiment of this specification is implemented.

It can be understood that a structure shown in the embodiments of this specification does not constitute a specific limitation on the apparatus in the embodiments of this specification. In some other embodiments of this specification, the above-mentioned apparatus can include more or fewer components than those shown in the figure, or combine some components, or split some components, or have different component arrangements. The components in the figure can be implemented by hardware, software, or a combination of software and hardware.

The embodiments in this specification are described in a progressive manner. For the same or similar parts of the embodiments, references can be made to the embodiments. Each embodiment focuses on a difference from other embodiments. Particularly, the apparatus embodiments are basically similar to the method embodiments, and therefore are described briefly. For related parts, references can be made to related descriptions in the method embodiments.

A person skilled in the art should be aware that in the above-mentioned one or more examples, functions described in this specification can be implemented by hardware, software, firmware, or any combination thereof. When these functions are implemented by software, they can be stored in a computer-readable medium or transmitted as one or more instructions or code on the computer-readable medium.

In the above-mentioned specific implementations, the objectives, technical solutions, and beneficial effects of this application are further described in detail. It should be understood that the above-mentioned descriptions are merely specific implementations of this application, but are not intended to limit the protection scope of this application. Any modification, equivalent replacement, improvement, etc. made based on the technical solutions of this application shall fall within the protection scope of this application.

1. A service providing method for a third-party mini-program, wherein the method comprises:
generating and storing an application key AppKey;
delivering the AppKey to a first-party client, so the first-party client delivers the AppKey to a third-party client;
obtaining an open authentication system identifier OpenID, and generating a session identifier SessionID;
establishing a correspondence between the AppKey, the OpenID, and the SessionID;
receiving a service data request sent by the first-party client, wherein the service data request carries the SessionID, an AppKey, and a service parameter;
determining whether the SessionID and the AppKey that are carried in the service data request conform to the established correspondence;
if yes, sending a service resource request to a third-party server, wherein the service resource request carries the service parameter and an OpenID corresponding to the SessionID carried in the service data request; and
sending, to the first-party client, response data returned by the third-party server, so the first-party client sends the response data to the third-party client.

2. The method according to claim 1, wherein before generating and storing the application key AppKey, the method further comprises:
receiving an initialization key that is pre-agreed upon with the third-party client and that is forwarded by the first-party client;
verifying the initialization key; and
if the verification succeeds, performing the step of generating and storing an AppKey.

3. The method according to claim 1, wherein after generating the SessionID and before receiving the service data request sent by the first-party client, the method further comprises:
encrypting the SessionID by using the AppKey, and sending an encrypted SessionID to the first-party client, so the first-party client interacts with the third-party client to enable the first-party client to obtain a decrypted SessionID.

4. The method according to claim 1, wherein after generating the SessionID and before receiving the service data request sent by the first-party client, the method further comprises:
generating a session key, wherein the session key has a same lifecycle as the SessionID, and sending the session key and the SessionID to the first-party client;
the service parameter in the service data request sent by the first-party client is encrypted by the first-party client by using the session key; and
after it is determined that the SessionID and the AppKey that are carried in the service data request conform to the established correspondence and before the service resource request is sent to the third-party server, the method further comprises: decrypting an encrypted service parameter in the service data request by using the session key, to obtain the service parameter.

5-14. (canceled)

15. A computing device, comprising a memory and a processor, wherein the memory stores executable code, and when executing the executable code, the computing device is caused to:
generate and store an application key AppKey;
deliver the AppKey to a first-party client, so the first-party client delivers the AppKey to a third-party client;
obtain an open authentication system identifier OpenID, and generate a session identifier SessionID;
establish a correspondence between the AppKey, the OpenID, and the SessionID;
receive a service data request sent by the first-party client, wherein the service data request carries the SessionID, an AppKey, and a service parameter;
determine whether the SessionID and the AppKey that are carried in the service data request conform to the established correspondence;
if yes, send a service resource request to a third-party server, wherein the service resource request carries the service parameter and an OpenID corresponding to the SessionID carried in the service data request; and
send, to the first-party client, response data returned by the third-party server, so the first-party client sends the response data to the third-party client.

16. The computing device according to claim 15, wherein before generating and storing the application key AppKey, the computing device further comprises being caused to:
receive an initialization key that is pre-agreed upon with the third-party client and that is forwarded by the first-party client;
verify the initialization key; and
if the verification succeeds, perform the step of generating and storing an AppKey.

17. The computing device according to claim 15, wherein after generating the SessionID and before receiving the service data request sent by the first-party client, the computing device further comprises being caused to:
encrypt the SessionID by using the AppKey, and send an encrypted SessionID to the first-party client, so the first-party client interacts with the third-party client to enable the first-party client to obtain a decrypted SessionID.

18. The computing device according to claim 15, wherein after generating the SessionID and before receiving the service data request sent by the first-party client, the computing device further comprises being caused to:
generate a session key, wherein the session key has a same lifecycle as the SessionID, and send the session key and the SessionID to the first-party client;
the service parameter in the service data request sent by the first-party client is encrypted by the first-party client by using the session key; and
after it is determined that the SessionID and the AppKey that are carried in the service data request conform to the established correspondence and before the service resource request is sent to the third-party server, the computing device further comprises being caused to: decrypt an encrypted service parameter in the service data request by using the session key, to obtain the service parameter.

19. A non-transitory computer-readable storage medium, wherein the non-transitory computer-readable storage medium stores a computer program, which when executed by a processor causes the processor to:
generate and store an application key AppKey;
deliver the AppKey to a first-party client, so the first-party client delivers the AppKey to a third-party client;
obtain an open authentication system identifier OpenID, and generate a session identifier SessionID;
establish a correspondence between the AppKey, the OpenID, and the SessionID;
receive a service data request sent by the first-party client, wherein the service data request carries the SessionID, an AppKey, and a service parameter;
determine whether the SessionID and the AppKey that are carried in the service data request conform to the established correspondence;
if yes, send a service resource request to a third-party server, wherein the service resource request carries the service parameter and an OpenID corresponding to the SessionID carried in the service data request; and
send, to the first-party client, response data returned by the third-party server, so the first-party client sends the response data to the third-party client.

20. The non-transitory computer-readable storage medium according to claim 19, wherein before generating and storing the application key AppKey, the processor further comprises being caused to:
receive an initialization key that is pre-agreed upon with the third-party client and that is forwarded by the first-party client;
verify the initialization key; and
if the verification succeeds, perform the step of generating and storing an AppKey.

21. The non-transitory computer-readable storage medium according to claim 19, wherein after generating the SessionID and before receiving the service data request sent by the first-party client, the processor further comprises being caused to:
encrypt the SessionID by using the AppKey, and send an encrypted SessionID to the first-party client, so the first-party client interacts with the third-party client to enable the first-party client to obtain a decrypted SessionID.

22. The non-transitory computer-readable storage medium according to claim 19, wherein after generating the SessionID and before receiving the service data request sent by the first-party client, the processor further comprises being caused to:
generate a session key, wherein the session key has a same lifecycle as the SessionID, and send the session key and the SessionID to the first-party client;
the service parameter in the service data request sent by the first-party client is encrypted by the first-party client by using the session key; and
after it is determined that the SessionID and the AppKey that are carried in the service data request conform to the established correspondence and before the service resource request is sent to the third-party server, the computing device further comprises being caused to: decrypt an encrypted service parameter in the service data request by using the session key, to obtain the service parameter.
